(19) United States
(12) Patent Application Publication
(10) Pub. No.: US 2008/0003384 A1
(43) Pub. Date: Jan. 3, 2008

(54) Multi-layer coatings to increase water and grease resistance of porous materials and materials having such protection

(75) Inventors: Christopher B. Murphy, Woodridge, IL (US); Jon O. Fabri, Charleston, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: Polymer Ventures, Inc., Charleston, SC (US)

(21) Appl. No.: 11/478,018

(22) Filed: Jun. 29, 2006

(51) Int. Cl. B41M 5/00

(52) U.S. Cl. 428/32.26

(57) ABSTRACT

A method of improving gas, water, water vapor, and/or grease resistance of a porous material is disclosed which comprises treating the material with a first treatment agent followed by the application of wax and poly(vinyl alcohol) and optionally a polyamine. Porous materials that have a multi-layer coating that includes a first coating of a first treatment agent and a second coating of wax, poly(vinyl alcohol), and optionally a polyamine are also disclosed.

### BACKGROUND OF THE INVENTION

(1) Field of the Invention

The present invention relates to methods to impart grease resistance and/or water resistance to materials, and more particularly to methods of improving grease resistance and/or water resistance that involve two or more treatment agents.

(2) Description of the Related Art

Materials, such as paper and textiles, are commonly treated or coated to improve their resistance to liquids such as water, grease and oil. Commercial compounds such as Scotchgard™ and Scotchban®, both products of Minnesota Mining and Manufacturing Co. have been widely used to improve the barrier properties of papers, textile fabrics, nonwoven fabrics, upholstery, carpet fibers, and the like.

ScotchgardTM® and Scotchban®, and similar products, contain fluorochemicals, which have recently become the object of health and environmental concerns because of their persistence and tendency to bioaccumulate. Consequently, there is strong interest in replacing or reducing the use of fluorochemical compounds such as perfluorooctane sulfonate (PFOS), perfluorooctanoate (PFOA), polytetrafluoroethylene (PTFE), perfluoro-n-decanoic acid (PFDA) and other perfluorinated compounds that are widely used for imparting grease, oil, and/or water resistance to the substrates to which they are applied.

Recently several products have been introduced into the marketplace as potential replacements for the fluorochemical compounds. These materials are based on inorganic materials like silica and on organic polymers, or combinations of those materials. However, to date, these replacements have fallen short of the cost/performance standards established by the fluorinated compounds in this area of use.

It is well known to modify the barrier properties of various materials by the addition of a wax, and paraffin waxes have been used in many of these techniques. Examples of the use of waxes for surface treatment, coating, and the like can be found in U.S. Pat. No. 4,117,199. In U.S. Pat. No. 4,097,297 to Keene, an oil and water repellant barrier coating is described that consists essentially of a film forming polymer, a fluorochemical surface tension modifier, and a plasticizer. Waxes, coalescing solvents, and dyes are optionally included.

Poly(vinyl alcohol) has been widely used in films and coatings for properties that range from water dispersability to barrier properties. Examples of these uses are found in U.S. Pat. Nos. 5,468,526, 5,110,390, 5,283,090, 6,113,978, US 2005/0042443 A1, and GB 2 185 404A, among others. In U.S. Pat. No. 5,981,011 to Overcash et al. a coated sheet material is described that has as one component a barrier coating comprising a polymer mixture in which one polymer can be poly(vinyl alcohol).

Several references describe circumstances where either paraffin wax or poly(vinyl alcohol) can be used for one purpose or another. For example, in U.S. Pat. No. 5,620,793 to Suzuki et al., a printing paper is provided that has no special coating on the printing face and does not cause bronzing in ink-jet printing. The paper also comprises an ink penetration-retarding agent on the printing face that can be, among other things, either poly(vinyl alcohol) or paraffin wax. In U.S. Pat. No. 5,648,164 to Sakaki et al., a recording paper is described in which both poly(vinyl alcohol) or paraffin wax are mentioned as potential ink penetration-retarding agents. In U.S. Pat. No. 6,919,111, to Swoboda et al., a cellulosic multi-ply paperboard is described that contains predominantly cellulosic fibers, a bulk and porosity enhancing additive, and a size press applied binder coating. The paperboard can be coated with either a binder, such as poly(vinyl alcohol), or with a wax. A similar composition having a coating of either a binder such as poly(vinyl alcohol) or a wax is described in U.S. Pat. No. 6,379,497, to Sandstrom et al.

In U.S. Pat. No. 5,843,544 to Andersen et al., hinged starch-bound cellular matrix clam-shell type containers are described that can be coated on the interior with a wax coating. The container can also be coated on the exterior with an elastomeric coating that can comprise poly(vinyl alcohol) in order to strengthen the outer surface and reduce its tendency to fracture during the hinging action. Similar articles produced from a starch-bound cellular matrix reinforced with dispersed fibers and having optional coatings of materials such as poly(vinyl alcohol) or wax are discussed in U.S. Pat. Nos. 5,660,900 and 5,683,772 to Andersen et al.

Wenzel et al., in U.S. Pat. Nos. 5,654,039 and 5,837,383, describe recyclable and compostable coated paper stock comprising a substrate having a primer coat that can be poly(vinyl alcohol) and, in addition, having a top coat that can include a wax composition, which can be a paraffin wax. However, mixtures of primer coat and top coat materials are not described.

In U.S. Pat. No. 5,626,945 to Berzins et al. and U.S. Pat. No. 5,635,279 to Ma et al., repulpable, water repellant paperboard is described that has a coating comprising a wax component that can be a paraffin wax, mixed with a polymer matrix of polymer chains ionically cross-linked through pendant carboxylate groups. A preferred polymer matrix was described as comprising a polystyrene-butadiene polymer copolymerized with a monomer having carboxylic acid pendant groups. In the U.S. Pat. No. 5,635,279, poly(vinyl alcohol) is described as being an ionically cross-linkable polymer that could be used in the invention, however, some carboxylate functionality must be added to the polymer prior to use by copolymerizing with a monomer having carboxylic acid pendant groups.

Other references have described the use of both waxes and substances such as poly(vinyl alcohol) for various purposes, in particular in the field of surface preparations for paper and textiles. For example, U.S. Pat. No. 5,151,404 to Suzuki et al. describes thermosensitive recording paper that does not curl and provides clear images with high image density. The inventors claim that paraffin wax can be used as a sizing agent in the paper, and poly(vinyl alcohol) can be used as a stiffness-imparting agent.

U.S. Pat. No. 5,763,100 to Quick et al., describes recyclable acrylic coated papers that have water and grease resistance and limited moisture vapor transmission characteristics. The papers can have a primer coat, which is commonly a water-based dispersion of a polymer such as poly(vinyl alcohol), and a further coating of a water-based emulsion of an acrylic-styrene copolymer and a wax, which can be a paraffin wax.

In U.S. Pat. No. 5,180,614 to Escabasse, a supple biodegradable sheet is described that is resistant to bursting and has poor water and other liquid absorbing power. The sheet comprises fibers, an optional moisture resisting agent, a binder, which can be poly(vinyl alcohol), a moisture retaining agent, and a sizing agent, which can be a paraffin wax.

Dettling, in U.S. Pat. No. 5,773,131, describes a paper product having a flavor seal and a vapor barrier that is produced by applying a primer coating to the paper that can include poly(vinyl alcohol), and after polymerizing the coating to form an amorphous net structure, applying a cover coating mixture suitable for generating a vapor seal. The cover coating mixture can include paraffin wax.

Dragner et a., in U.S. Pat. No. 5,795,932, describe a surface sizing composition for nonwoven substrates that includes a waxy material, that can be a paraffin wax, but is preferably a stearylated melamine, and a surfactantless vinyl polymer or copolymer emulsion that contains an alkali soluble, acid containing copolymer, which acts as the only surfactant for the waxy material.

In U.S. Pat. No. 5,928,741 to Andersen et al., laminated articles fashioned from sheets having a highly inorganically filled organic polymer matrix are described. The sheets can be coated with various materials, selected to improve water penetration, or grease and oil penetration, or to render the article substantially liquid-tight, or pressure-tight, or to increase the flexibility of the article, and poly(vinyl alcohol) and waxes are included in a list of several possible coating materials. It is stated that mixtures of the coating materials can also be used, but no particular mixture is identified as being preferred. Methods for the production of articles of a similar nature are described by Andersen et al. in U.S. Pat. Nos. 5,580,409 and 5,800,647.

In U.S. Pat. No. 6,159,612, Chu et al. describe multilayer films having a barrier layer containing a wax. The films are said to provide an effective moisture and oxygen barrier without requiring such barrier agents as polyterpenes, alicyclic hydrocarbons, or high barrier polyvinylidene chloride coatings. The films include a layer comprising an olefin polymer, and a barrier layer comprising a syndiotactic polypropylene homopolymer and a wax. They can further include an outer layer that can be coated, for example, with a poly(vinyl alcohol) coating.

Chang et al. describe a method of making a flushable film having barrier properties in U.S. Pat. No. 6,479,105. The film can have a water-dispersible substrate layer that can comprise poly(vinyl alcohol) that is covered with a coating of a low molecular weight amorphous poly(alpha-olefin) that can be admixed with a branched paraffin wax.

In WO 02/14426 to Dixit et al. (also US 2004/0005341 A1) a formulation for providing oil and grease resistance and release paper properties is described as including a fatty acid melamine and paraffin wax emulsion and a poly(vinyl alcohol). Alternatively, the formulation can include a fatty acid melamine wax and a poly(vinyl alcohol). A preferred fatty acid melamine wax is a stearylated melamine wax. The formulation can be used as a coating to provide oil and grease resistance on paper and paperboard, and can also be applied inline on a paper machine.

Despite the advances that recently have been made in the attempt to find effective and environmentally benign alternatives to fluorochemical barrier coatings, there remains a need for compounds or methods that can be used to reduce the use of or to replace the perfluorinated compounds in present commercial use as greaseproofing and waterproofing agents for paper and the like. It would be useful if such compounds and methods were cost effective and easy to apply. It would also be useful if such compounds and methods were more environmentally benign than the current fluorochemical compounds and it would be useful if such compounds and methods were totally free of such fluorochemical compounds.

### SUMMARY OF THE INVENTION

Briefly, therefore the present invention is directed to a novel method of improving the gas, water, water vapor, or grease resistance of a porous material, the method comprising: applying to the porous material a first treatment agent; and after the first treatment agent has been applied to the porous material, applying to a surface of the porous material wax, poly(vinyl alcohol), and optionally a polyamine, thereby improving the gas, water, water vapor, or grease resistance of the porous material.

The present invention is also directed to a novel porous material having improved gas, water, water vapor and/or grease resistance comprising the porous material having a surface on which is a first coating of a first treatment agent and a second coating comprising wax, poly(vinyl alcohol) and optionally a polyamine over the first coating.

The present invention is also directed to a novel porous material that has been treated by the method described above.

Among the several advantages found to be achieved by the present invention, therefore, may be noted the provision of compounds and methods that effectively improve the grease and/or the water resistance of a material and which are cost effective and easy to apply, the provision of such compounds and methods that are more environmentally benign than the current fluorochemical compounds, and the provision of such compounds and methods that require reduced amounts of, or are free of fluorochemical compounds.

### DETAILED DESCRIPTION OF THE PREFERRED EMBODIMENTS

In accordance with the present invention, it has been discovered that treatment of porous materials, such as paper, with a first treatment agent, such as a conventional polymer latex/filler surface coating, followed by a treatment with wax, poly(vinyl alcohol) and optionally a polyamine, greatly improves the gas, water, water vapor, and/or grease resistance of the materials, even at relatively low levels of the second treatment. In preferred embodiments, the degree of improvement is more than would have been expected based merely on the additive effect of the two treatments.

In tests with 190# whiteboard, a commercial coating of a polymer latex and filler provided grease resistance (reported as Kit numbers measured according to TAPPI TEST METHOD T-559 “Grease Resistance for Paper and Paperboard”) of about zero (0), but treatment of the coated whiteboard with a wax/poly(vinyl alcohol)/polyamine coating, even at dosage rates of under 10 lbs. d.s./ton of paper, improved Kit numbers to about 5, while application of under 15 lbs. d.s./ton improved Kit numbers to about 8, and under 20 lbs. d.s./ton improved Kit numbers to about 12.

Another feature of the present invention is that such superior performance can be obtained without the use of higher, and more expensive, grades of poly(vinyl alcohol). It has been shown that the present methods can be carried out successfully with less expensive grades of poly(vinyl alcohol), such as partially hydrolyzed and intermediate hydrolyzed poly(vinyl alcohol), and that the use of higher grades, such as fully hydrolyzed or super hydrolyzed, is not required. This feature is highly advantageous in controlling the expense of the coating procedure, and improves the cost effectiveness of the innovative method.

In a further embodiment, the inventors have found that the addition of a polyamine to the combination of wax and poly(vinyl alcohol) provides additional improvement in the performance of the compositions.

When the present specification refers to an improvement in the gas, water, water vapor, and/or grease resistance of a porous material, what is meant is any increase, no matter how small, in the resistance of the porous material to penetration by any type of gas, water, water vapor and/or grease. The term “grease”, as used herein, refers to any type of oil, fat, or lipid, whether natural or synthetic, and includes without limitation, natural fats and oils, such as seed oils, including corn oil, soybean oil, rapeseed oil, sunflower oil, and the like, lard, animal fats, and synthetic oils, such as silicone oil and the like, and also liquid, semi-solid and solid hydrocarbons.

In an embodiment of the invention, improving the gas, water, water vapor, or grease resistance of the porous material comprises increasing the grease resistance of the porous material as measured by Kit number, where the wax, poly(vinyl alcohol) and optional polyamine are applied in an amount sufficient to improve the grease resistance by at least 3 Kit numbers. In another embodiment, improving the gas, water, water vapor, or grease resistance of the porous material comprises increasing the grease resistance of the porous material as measured by Kit number, where the wax, poly(vinyl alcohol) and optional polyamine are applied in an amount sufficient to improve the grease resistance by at least a factor of 2 but no less than 2 Kit numbers.

In the present specification, the term “coating” is not intended to be limiting to a surface coating, unless that is explicitly stated. By way of example, a coating of the first treatment agent can be applied by adding the first treatment agent to the wet end of a paper machine. The first treatment agent, therefore, is distributed throughout the depth of the paper, but such application is still embraced by the term “coating”, as used herein. On the other hand, the terms “surface coating” are meant to refer to a coating that is applied to the outer surface of a porous material, such as a spray or roll coating applied to a dry paper web.

In the present method, the first treatment agent can be any treatment agent that is know for use in sizing, increasing water resistance, gas resistance, water vapor resistance, wet strength, dry strength, softness, drape, hand, and/or the printability of a porous material, except those agents that are not compatible with a subsequent treatment comprising wax and poly(vinyl alcohol), optionally with a polyamine.

The first treatment agent can be applied during the formation or manufacture of the porous material, such as at the wet end of a paper machine. Preferably, however, the first treatment agent is applied to a surface of the porous material after the material has been formed. An example of this is the application of the first treatment agent as a coating on paper at the dry end of the paper machine, or at any time after formation of the paper web.

The first treatment agent can be provided in the form of a waterborne coating formulation or a solventborne coating formulation. Commonly, the first treatment agent comprises a polymer binder. The polymer can be applied neat, as in a hot melt roll application (such as is used for the application of a polyethylene wax to paperboard for the manufacture of milk cartons), or it can be applied as a solution or in a dispersion as a latex. It is common that the polymer is dispersed as a waterborne latex due to the low toxicity, safety and low organic emissions of the application process.

Examples of polymers that are useful as the polymer binder of the first treatment agent include poly(vinyl alcohol), polyacrylate, polystyrene/polyacrylic copolymer, cellulose derivative, nitrocellulose, vinyl chloride, vinyl chloride copolymers, vinyl acrylate copolymers, vinyl acetate homopolymers, vinyl acetate copolymers, styrene butadiene polymers, styrene butadiene acrylonitrile polymers, polyvinylacetate, proteins, milk proteins, starch, and mixtures of any of these.

In one embodiment, the first treatment agent can include wax, poly(vinyl alcohol) and optionally a polyamine. In other words, it can be the same as, or similar to the composition that is used in the subsequent wax/poly(vinyl alcohol) and optional polyamine treatment.

The first treatment agent can have additional components and common additional components can include pigments, such as natural or synthetic pigments; minerals, such as calcium carbonate, titanium dioxide, Kaolin clay, Montmorillionite clay, and gypsum; organic opacifiers; lubricants; surface sizes, such as starch; saturants; release coatings; rheology modifiers; dispersants; insolubilizers; or plasticizers, such as dioctyl phthalate, tricresyl phosphate, and castor oil. The first treatment agent can include any of these materials and any mixtures thereof. In some embodiments, latex binders with inorganic fillers, as described above, are preferred.

The first treatment agent is applied in any amount that will achieve the beneficial effects described above. However, in some embodiments, it is preferred that the first treatment agent is applied in an amount of from about 0.1 to about 50 g/m². It is more preferred that the amount of the first treatment agent to be applied is from about 1 to about 30 g/m², and an amount of from about 2 to about 20 g/m² is even more preferred.

Many commercially available materials may be used as the first treatment agent. These include products marketed under the tradenames of RHOPLEX, POLYCO, ROPAQUE, ACUMER and TAMOL, all available from RhomNova, Mogadore, Ohio.

It should be noted that the present invention embraces the embodiment where the step of applying the first treatment agent is done by another. In other words, the first step of applying the first treatment agent is intended to embrace the act of selecting a pre-coated porous material, to which one can then apply the wax/poly(vinyl alcohol) and optional polyamine.

Although the present invention offers an advantage of providing superior water and grease resistance with the use of coatings that are free of fluorochemical compounds, the invention also embraces the situation where a reduced amount of a typical fluorochemical water, oil and/or grease proofing agent, such as perfluorooctane sulfonate (PFOS), perfluorooctanoate (PFOA), polytetrafluoroethylene (PTFE), perfluoro-n-decanoic acid (PFDA), or the like, is used in conjunction with the present method to obtain superior Kit numbers. The conventional fluorochemical agent can be applied prior to the present method, or is optionally applied as the first treatment agent, and the second treatment agent is then applied to provide superior levels of grease and/or oil and water resistance. When it is said that a reduced amount of a typical fluorochemical agent is used, it is meant that at least 10% less of the fluorochemical agent is used than would otherwise be required to obtain the Kit number that is achieved when the fluorochemical agent is used in conjunction with the present method. Preferably, the amount of the fluorochemical agent is 25% less, more preferably 50% less than would be required without the use of the novel method.

In the present method, after the application of the first treatment agent to the porous material (or the selection of a porous material having had a first treatment agent applied to it), wax, poly(vinyl alcohol), and optionally a polyamine is applied to a surface of the porous material, thereby improving the gas, water, water vapor, or grease resistance of the porous material.

Any suitable poly(vinyl alcohol) can be used in the present methods and compositions. Poly(vinyl alcohol) is a polymer comprising vinyl acetate monomer units, some of which have been hydrolyzed to yield alcohol functional groups on the polymer. Poly(vinyl acetate) and poly(vinyl acetate-co-vinyl alcohol) are also included in the definition of poly(vinyl alcohol). The polymer can contain other co-monomers such as ethylene, propylene, butylene, ethylene oxide, propylene oxide, and the like without departing from the scope of the invention. The poly(vinyl alcohol) can be in the physical form of a solid, an emulsion, a suspension, or a liquid solution.

The physical properties of poly(vinyl alcohol) are controlled by molecular weight and the degree of hydrolysis, and a wide range of commercial grades is offered by poly(vinyl alcohol) manufacturers. Some of the commercially available grades of poly(vinyl alcohol) are: Partially Hydrolyzed, Intermediate Hydrolyzed, Fully Hydrolyzed, and Super Hydrolyzed. The molecular weight depends on the conditions of polymerization, and the degree of hydrolysis is defined as the percent of acetate groups replaced by hydroxyl groups during the hydrolysis reaction. The specific gravity of poly(vinyl alcohol) solutions depends on concentration and temperature and is independent of grade. Poly(vinyl alcohol) reacts in a manner similar to secondary alcohols.

The poly(vinyl alcohol) employed in accordance with this invention may be any grade poly(vinyl alcohol) that is compatible with paraffin waxes and optionally with polyamines such as dicyandiamide-formaldehyde condensate and that provides improved grease resistance or improved water resistance, or both, when applied to a material, such as paper, in combination with paraffin wax and optionally a polyamine.

In a preferred embodiment, the poly(vinyl alcohol) component comprises a partially hydrolyzed poly(vinyl alcohol), typically having a percent hydrolysis of about 87%-89% and a viscosity of about 45-55 centipoise (4% aqueous solution at 20° C.).

The manufacture of poly(vinyl alcohol) involves starting with polyvinyl acetate and converting that material to poly(vinyl alcohol) generally by base-catalyzed methanolysis. Polyvinyl acetate polymerization is done by conventional processes such as, for example, solution, bulk or emulsion polymerization. The polymerization step controls the ultimate molecular weight of the poly(vinyl alcohol). Catalyst selection, temperature and solvent control the degree of polymerization.

The degree of hydrolysis of poly(vinyl alcohol) is controlled during the alcoholysis reaction and is independent of molecular-weight control. Fully hydrolyzed poly(vinyl alcohol) is obtained if methanolysis is allowed to go to completion. The reaction can be terminated by neutralizing or removing the sodium hydroxide catalyst. The addition of small amounts of water to the reactants promotes saponification of polyvinyl acetate, which consumes sodium hydroxide. The extent of hydrolysis is inversely proportional to the amount of water added. Typical degrees of hydrolysis of commercial grades of poly(vinyl alcohol) are: Super Hydrolyzed (over 99.3%), Fully Hydrolyzed (98.0-98.8%), Intermediate Hydrolyzed (91.0-96.5%, with range varying by molecular weight), and Partially Hydrolyzed (86.0-89.0, with range varying by molecular weight).

An example of a commercially-available poly(vinyl alcohol) which is partially hydrolyzed and which is suitable for use in the present invention is Celvol 840, which is available from Celanese Corporation of Dallas, Tex.

In the present invention, the poly(vinyl alcohol) can be used neat, or it can be used in combination with a defoamer. It is not uncommon to add a defoamer when using an intermediate or partially hydrolyzed grade or poly(vinyl alcohol).

Any wax can be used in the methods and compositions of the present invention. Useful waxes may be natural or synthetic, or combinations thereof, and may be macrocrystalline or microcrystalline. The wax can be obtained from animal, vegetable or mineral sources, or it may be produced synthetically. Useful waxes generally have melting points within the range of about 20° C. to about 200° C., and include animal waxes, mineral waxes, vegetable waxes, insect waxes, and synthetic waxes including: beeswax; bayberry-myrtle; candelilla; caranday; carnauba; castor bean wax; esparto grass wax; Japan wax; montan crude wax; ouricury; retamo-ceri nimbi; shellac wax; spermaceti; sugar cane wax; and wool wax-lanolin.

Of these waxes, petroleum waxes and synthetic waxes are preferred for the methods and compositions of the present invention. Synthetic waxes include the ester waxes made by esterifying acid waxes, such as montan wax, with alcohols and/or glycols. Paraffins and chlorinated paraffin waxes also are of interest as the wax components of the present methods and compositions, as are waxes produced by the emulsion polymerization of ethylene, styrene, or acrylates (weight average molecular weights of about 10,000 to about 50,000). Oxidized hydrocarbon waxes, such as those manufactured from the Fisher-Tropsch paraffins, and the microcrystalline petroleum waxes (ester-type waxes) also are useful in the methods and compositions of the present invention.

Other synthetic waxes of entirely different structure such as the fatty amides, imides, amines, and nitrites can be waxlike and can be used in the present invention. The polyoxyethylenes or carbowaxes are an important group of waxes because of their solubility properties and compatibility with fatty materials.

The petroleum waxes, particularly paraffin waxes but also the microcrystalline waxes are particularly preferred for use in the present invention. The petroleum waxes are predominantly long chain (C₁₆-C₅₀) alkane compounds. The paraffins are mostly straight-chain molecules, but may have branched claims. The microcrystalline waxes range in molecular weight from about 400 to about 700 and have average molecules of about 40 to about 50 carbon atoms. The microcrystalline waxes have more branched-chain molecules than in paraffin waxes, containing an average of three carbon atoms per side chain. Oxidized microcrystalline waxes also are useful in the compositions of the present invention. Petroleum waxes contains both solid and liquid hydrocarbons with the liquid hydrocarbons held in discrete droplets within the petroleum wax. The paraffin waxes used in the compositions of the present invention may be crude scale wax and/or fully refined wax.

Synthetic paraffin waxes are mixtures of saturated straight-chain paraffinic hydrocarbons with short side chains (C₁-C₄). The weight average molecular weight is about 700 to about 800 or about 45-60 carbon atoms per molecule.

Paraffin wax is a preferred wax for use in the present invention. Any type or grade of paraffin wax can be used in the present invention that is compatible with poly(vinyl alcohol) and optionally with a polyamine, and that provides improved resistance to grease or improved resistance to water, or both, when applied to a material such as paper in combination with poly(vinyl alcohol) and optionally with a polyamine such as dicyandiamide-formaldehyde condensate.

Preferred paraffin waxes are unbranched or sparsely branched waxy white or colorless solid hydrocarbon mixtures that can be used to make candles, wax paper, lubricants, and sealing materials. The chemical composition of a preferred paraffin wax is a mixture of predominantly non-aromatic saturated hydrocarbons with the general formula CₙH₍₂ₙ₊₂₎ where n is preferably an integer between 12 and 50, and more preferably between 22 and 27. It is preferable that the paraffin has a melting point, or melting point range, between about 25° C. and about 200° C., more preferably between about 47° C. and 95° C., and yet more preferably between about 47° C. and abut 65° C., and is insoluble in water. An example of a preferred paraffin wax is available from Sigma-Aldrich, Milwaukee, Wis., as Cat. No. 31,765-9, having a CAS RN of 8002-74-2, and a melting point range of 52°-58° C.

Other organic materials can be used with, or added to, the wax without departing from the scope of the invention. For example, when the wax is to be used as an aqueous emulsion, it is common to add an emulsifier to the mixture to stabilize the emulsion. A commonly used emulsifier for this purpose is a styrene-acrylate copolymer. One such material is Morez 101 (a styrene-acrylate copolymer available from Rohm & Haas). The wax, water, and the emulsifier can be intermixed with high shear to form a stable emulsion, which can then be used in suitable amounts to produce the compositions of the present invention.

In some embodiments, it is preferred that paraffin wax and poly(vinyl alcohol) be the only materials present that have a significant effect on the grease and/or water resistance of the material. This is advantageous in circumstances where it is desirable to limit the cost or complexity of the treatment. In this instance, the treatment and compositions are said to consist essentially of poly(vinyl alcohol) and paraffin wax.

Optionally, a polyamine can be included as a component of the wax/poly(vinyl alcohol)/polyamine coating. The preferred polyamine is an amine-aldehyde condensate that is the reaction product of an amine containing an active hydrogen atom and an aldehyde. Examples of the amine include guanidine, urea, dicyandiamide, melamine, aniline, ethylenediamine, diethylenetriamine, monoethanolamine, diethanolamine, polyoxyalkyleneamines, polyoxyalkylenediamines, polyoxyalkylenetriamines, and the like. Examples of the aldehyde include formaldehyde, acetaldehyde, glutaraldehyde, glyoxal, hexamethylenetetramine, and paraformaldehyde. Accordingly, examples of polyamines that are useful in the present invention include a condensation product of any one or more of the amines listed above with any one or more of the aldehydes listed above. Polyamines that are useful in the present invention also include, without limitation, polyoxyalkyleneamines, polyoxyalkylenediamines, polyoxyalkylenetriamines, and mixtures of any of these. Examples of these materials include the Jeffamine® series of polyoxyalkyleneamines available from Huntsman Corporation, The Woodlands, Tex.

The reaction between the amine and aldehyde is usually conducted in aqueous solution and can be done at acid, neutral, or alkaline pH. The preferred condition is acid pH. Additional information regarding the production of suitable dicyandiamide-formaldehyde condensates can be found, for example, in U.S. Pat. No. 3,957,574 to Anderson.

A preferred polyamine for the present invention is a dicyandiamide-formaldehyde condensate. Examples of polyamines that are considered to be dicyandiamide-formaldehyde condensates, and which are useful in the invention are available from Polymer Ventures, Inc., Charleston, S.C., as RD111-013 and PC-540. RD111-013 is an acid condensation product of dicyandiamide, urea, and formaldehyde, and is available as a clear viscous solution of 46% d.s. having a viscosity of 50-250 cps and a pH of about 5.5. It is cationic and has a density of about 10 lbs/gal. PC-540 is an acid condensation product of dicyandiamide, urea, and formaldehyde and is available as a clear viscous solution of 50% d.s. having a viscosity of 10-100 cps and a pH of about 3.5. It is cationic and has a density of about 10 lbs/gal. Either of these polyamines can be used as commercially supplied.

Polyamines, and dicyandiamide-formaldehyde condensates in particular, are described in U.S. Pat. No. 6,576,086 by Ettl et al. as being useful as fixing agents in the production of paper or paperboard during paper stock draining. Similar materials are also discussed by Anderson in U.S. Pat. No. 3,957,574 as being preferred dye fixatives in a paper sizing agent. Dicyandiamide-formaldehyde condensates were also discussed as possible replacements for cationic starch in sizing agents in U.S. Pat. No. 4,222,820 to Hiskens et a., and as replacements for cationic resins used in a size for ink jet recording paper by Miyamoto in U.S. Pat. No. 4,576,867. However, none of these publications suggests the use of these polyamines in combination with a wax and a poly(vinyl alcohol) for use to improve grease and/or water resistance as is done in the present invention.

Furthermore, in U.S. Pat. No. 5,423,911 to Coutelle et al. and U.S. Pat. No. 5,660,622 to Nikoloff, the use of dicyandiamide-formaldehyde condensates as in paper coatings is described as being undesirable for one reason or another.

In the present invention, combinations of poly(vinyl alcohol) and wax, and optionally, a polyamine, are used in the second coating which provides the superior improvement in gas, water, water vapor and/or grease resistance that has been described.

When the first treatment agent or the second coating include only poly(vinyl alcohol) and wax as the penetration-resistance controlling agents, the two components can be used in any amounts. However, it is preferred that the ratio of the poly(vinyl alcohol) to the wax, by weight, is within a range of about 10:90 to about 90:10, a range of about 25:75 to about 75:25 is more preferred, a range of about 40:60 to about 60:40 is even more preferred, and a range of about 45:55 to about 55:45 is yet more preferred. In one embodiment, about 44% poly(vinyl alcohol) and about 56% wax, by weight, has been found to provide improved resistance.

When a polyamine is included in the second coating of the present invention, the poly(vinyl alcohol), the wax, and the polyamine can each be included in almost any relative amount. However, it has been found to be preferred that the three components be used in combinations in which the poly(vinyl alcohol) is within a range of about 3 to about 74% by wt. d.s. (where the dry solids (d.s.) include only the three components of interest), the wax is within a range of about 13-96 % by wt. d.s., and the polyamine is within a range of about 0.5-13% by wt. d.s. It is more preferred that the three components be used in combinations in which the poly(vinyl alcohol) is within a range of about 22 to about 68% by wt. d.s., the wax is within a range of about 25-74% by wt. d.s., and the polyamine is within a range of about 3-12% by wt. d.s. It is even more preferred that the three components be used in combinations in which the poly(vinyl alcohol) is within a range of about 38 to about 68% by wt. d.s., the wax is within a range of about 25-55% by wt. d.s., and the polyamine is within a range of about 6-12% by wt. d.s.

Alternatively, it has been found that the present methods and compositions can be achieved with combinations of poly(vinyl alcohol), wax, and polyamine having a weight ratio of the three components, respectively, of about 4/5/1, or 5/4/1, or 4.5/4.5/1.

In the present invention, the poly(vinyl alcohol) and the wax, and optionally the polyamine, can be intermixed into a composition that can be applied to the porous material to be treated. Alternative, the components can be applied separately. If the components are administered separately, they can be administered at approximately the same time, or they can be administered at different times. By way of example, separate solutions or emulsions of each component can be administered to the material to be treated, or the solutions or emulsions can be intermixed and then applied to the material as a single composition.

The poly(vinyl alcohol), wax, and optionally, the polyamine, of the present invention can be present in the solutions or emulsions of the invention, in almost any concentration. It is preferred that the present compositions contain from about 0.5% to about 60% by weight dry substance, based only on the poly(vinyl alcohol), wax, and polyamine, more preferred that they contain from about 1% to about 50% by wt. d.s., and even more preferred that they contain from about 20% to about 40% by wt. d.s. The present compositions can be diluted prior to use, and after dilution, a d.s. of about 3% to about 10% would be typical, and from about 5% to about 8% d.s. would be preferred.

The wax/poly(vinyl alcohol) and optionally polyamine are applied in a sufficient amount so as to provide the level of performance desired, and that amount may vary widely according to the porous material and its characteristics, such as porosity and surface roughness, as well as the type and amount of the first treatment agent. The rheological characteristics of the wax/PVOH/optional polyamine coating composition, such as viscosity can also have an affect. When the wax/PVOH/optional polyamine compositions are applied to sheet material having a measurable surface area, such as paper, for example, typical use rates, whether only poly(vinyl alcohol) and wax are used, or when a polyamine is also included, range from about 0.1 to about 4 lbs dry solids (d.s.) per 3000 ft² of surface of the material to be treated. It is preferred, however, that the components be applied at a rate of between about 0.1 and about 3 lbs d.s./3000 ft², even more preferred is an application rate of between about 0.15 to about 2.0 lbs d.s./3000 ft², more preferred is an application rate of between about 0.15 and 1.0 lbs d.s./3000 ft², and yet more preferred is an application rate of between about 0.4 and 1.0 lbs d.s./3000 ft².

As mentioned above, materials other than the poly(vinyl alcohol), wax, and optional polyamine can be used in the second treatment along with these ingredients without departing from the scope of the invention. It has been shown, for example, that it is often desirable to add an emulsifier along with the wax in order to form a stable aqueous emulsion. Other materials, such as colorants, dyes, preservatives, anti-fungal agents, surfactants, and the like, can also be used along with the wax, poly(vinyl alcohol) and optional polyamine in the present method.

Although it is possible, and even desirable, to provide and use the wax, the poly(vinyl alcohol) and the optional polyamine in aqueous solutions or emulsions, that is not required. In certain circumstances, for example, it might be useful to provide one or more of the components in an organic solvent, or in a molten form, or even in a dry form, such as a powder or flake.

The methods and compositions of the present invention can be used to treat materials of any sort that would benefit from an improvement in resistance to grease, or resistance to water, or both. The components of the present methods can be applied as coatings or in any other fashion at any point during the manufacture, packaging, storage, or use of the material to be treated.

When the present methods and compositions are used to form a coating, examples of materials to which they can be applied include packaging and non-packaging materials such as paper, cardboard, bakery board, butter and margarine chips, candy board, cup stock, frozen food containers, plate stock, artist's papers, asphalt laminations, carbonizing tissue, carton overwraps, cover and text papers, envelopes, garbage and trash bags, label papers, paper placemats, release papers, soap containers, wallpaper, liner board, folding cartons, multiwall bags, flexible packaging, duplicator and reproduction papers, support cards and medical dressings.

In addition, the present methods and compositions can be used to improve grease, oil, and moisture resistance of asphalt, wood, textile fabric, such as woven and non-woven fabrics, yarn, thread, carpets, upholstery, paperboard, formed articles, medical dressings, and the like.

Present materials to be treated are porous, and therefore not impervious to gas, water, water vapor and grease, although such resistance may vary widely. The present porous materials are commonly in sheet form and include substrates comprised of non-woven and woven polymers such as fabrics, and cellulose-based materials, such as paper and cardboard substrates, and the like. As used herein, the terms “sheet material” refer to a material in a form that has length and width dimensions that are each significantly greater than the thickness of the material. Examples of sheet materials include paper, paperboard, housewrap, tarpaper, and the like. The amount of sheet materials can often be characterized in terms of surface area, and the dosage rate of material that is added to a sheet material can be expressed on the basis of the surface area of the material. An example of this type of measurement is a dosage rate expressed as lbs per ft², or pounds per unit area.

In a preferred embodiment, the paper comprises a porous sheet material made of a cellulosic material, or a cellulose-based material. Such paper sheet materials include, for example, corrugated paperboard (or “cardboard”), newsprint paper, uncorrugated Kraft paper stock, pan liner paper stock, and the like. In addition to paper and paper-like materials, other cellulose-based sheet materials, such as pressed board, may also be suitable. It is also possible to use other fibrous materials for the substrate sheet material.

As discussed above, the present invention can be used to improve the grease and/or water resistance of paper. When used to treat paper, the first treatment agent alone or along with the first treatment agent and the wax/poly(vinyl alcohol) and optional polyamine can be added to the wet end of a typical Fourdrinier machine, or they can be used to coat paper after it has been dried. Alternatively, the first treatment agent can be added to the wet end of a paper machine and the wax/poly(vinyl alcohol) and optional polyamine can be added as a coating to the paper at the dry end of the machine.

When the first treatment agent and/or the wax/poly(vinyl alcohol) and optional polyamine are used as a coating, particularly on paper, the components may be applied as a solution, emulsion, or dispersion, by roll coater, brush, doctor blade or blade coater, sprayer or other such suitable application means. Typically, the coated materials are dried after the wax/poly(vinyl alcohol) and optional polyamine has been applied.

After the application of the wax/poly(vinyl alcohol) and optional polyamine, further coatings or treatments may be applied to the material. Such coatings could include heat shielding coatings, UV-resistant coatings, coatings with specific chemical resistance, or the like.

The coated material may be formed into a shaped article by means other than folding and gluing, such as, for example, by pressure-forming. Such shaped articles may be used for cooking or baking purposes. For example, the coated material may be used to make a container for storing food on a shelf (such as for storing pet food) while preventing penetration of grease, oil and/or water through the material. Or the coated material may be used to form a container such as a baking tray. Likewise, the coated material may be used to form a food receptacle such as a paper plate. Or the coated material may be used for fast-food containers, such as boxes for fried chicken, or food wrappers, such as wrapping materials for hamburgers and sandwiches. Thus, the coated material may be used for any of a variety of applications as a food container, wrapper or receptacle.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples all percentages are given on a weight basis unless otherwise indicated.

### COMPARATIVE EXAMPLE 1

This example shows the preparation, application and efficacy of compositions containing wax and polyvinyl alcohol and optionally a polyamine as coatings for paper.

Paper sheets were supplied from a paper mill in Wisconsin. The sheets were production run non- coated paper having a basis weight of 20 and 20.5 pounds per 3000 square feet.

Sheets were coated with a Gardco automated drawdown machine (available from Paul N. Gardner Company, Inc., Pompano Beach, Fla.) running at 1.5 cm/second, using various drawdown rod sizes to give coat weights ranging from 0.05 to 2 dry pounds/3000 square feet.

Grease resistance tests were conducted in accordance with TAPPI TEST METHOD T-559 “Grease Resistance for Paper and Paperboard”

Compositions A, B, and C, were made up as aqueous solutions or emulsions with the various components of the present compositions.

### Composition A (Poly(vinyl Alcohol) Solution in Water).

Distilled water (450 g) was added to a 1-liter glass reaction flask fitted with a condenser, and temperature probe. Agitation was started using an overhead mixer and a glass rod fitted with a half moon mixing blade. Celvol 840 (50 g), a partially hydrolyzed poly(vinyl alcohol) (PVOH) available from Celanese Ltd., was slowly poured into the vortex to ensure full welting of the PVOH particles. The temperature was then increased to 85-90° C. and the solution was allowed to cook for 1 hour until the PVOH was fully dissolved.

### Composition B (Solution of Poly(vinyl Alcohol) and Polyamine in Water)

Distilled water (439.5 g) was added to a 1-liter glass reaction flask fitted with a condenser, and temperature probe. Agitation was started using an overhead mixer and a glass rod fitted with a half moon mixing blade. Then 15.5 g of a 50% active urea-dicyandiamide-formaldehyde copolymer (polyamine) was added. Celvol 840 (45 g) was slowly poured into the vortex to ensure full welting of the PVOH particles. The temperature was then increased to 85-90° C. and the solution was allowed to cook for 1 hour until the PVOH was fully dissolved.

### Composition C (Emulsion of Paraffin Wax in Water with Styrene-acrylate Copolymer as an Emulsion Stabilizer)

Distilled water (300 g), 50 g of Morez 101 (a styrene-acrylate copolymer available from Rohm & Haas), and 150 g of paraffin wax (Sigma-Aldrich 52-58° C. melting point) was added to a 1-liter glass reaction flask fitted with a condenser, and temperature probe. Agitation was started using an overhead mixer and a glass rod fitted with a half moon mixing blade. The reactor was heated to 80° C. and allowed to mix for 1 hour until booth the Morez and paraffin was completely melted. A lab homogenizer (Ultra Turrax T25 from IKA Works, Inc.) was the placed in the reactor and the reactor was allowed to cool to ˜60° C. At 60° C. the homogenizer was turned on at 24,000 rpm for several minutes.

### Compositions D-J (Mixtures of Wax and PVOH and Optionally with Polyamine)

Compositions D-J where made in accordance with the relative amounts of components as shown in Table 1. The appropriate amount of Composition A or Composition B was placed in a 500 ml beaker fitted with an over head mixing shaft, and the appropriate amount of Example C was slowly added with agitation until the blend was smooth. Table 2 shows the amounts of each of the three ingredients in each of Compositions A-J in terms of the percent by weight of the component relative to the dry weight of the total amounts of wax, poly(vinyl alcohol) and urea-dicyandiamide-formaldehyde copolymer condensate in the composition. Accordingly, any amount of other materials, such as emulsifiers, and the like, are not reflected in the calculation shown in Table 2.

TABLE 1
Grease and water resistance-improving compositions of
the present invention having various relative amounts of
poly(vinyl alcohol) and wax.

| Composition | Weight Ratio (g/g) |
|---|---|
| D | B/C (95/5) |
| E | B/C (90/10) |
| F | B/C (70/30) |
| G | B/C (50/50) |
| H | B/C (30/70) |
| I | B/C (10/90) |
| J | A/C (70/30) |

TABLE 2
Relative amounts of components in the compositions of
Table 1 in terms of percent dry weight.

| | PVOH^{a} | Wax^{b} | Polyamine^{c} |
|---|---|---|---|
| Composition | (% by wt. d.s.)^{d} | (% by wt. d.s.)^{d} | (% by wt. d.s.)^{d} |
| A | 100 | 0 | 0 |
| B | 85.3 | 0 | 14.7 |
| C | 0 | 100 | 0 |
| D | 74.2 | 13 | 12.8 |
| E | 67.5 | 25 | 11.6 |
| F | 38.4 | 54.9 | 6.6 |
| G | 22.2 | 74 | 3.8 |
| H | 11.2 | 86.9 | 1.9 |
| I | 3.2 | 96.2 | 0.6 |
| J | 43.8 | 56.2 | 0 |
| Control^{e} | 0 | 0 | 0 |

Notes:
^{a}PVOH is poly(vinyl alcohol) Celvol 840, from Celanese Corporation.
^{b}Wax is paraffin wax having a melting point of 52°–58° C. from Sigma-Aldrich.
^{c}Polyamine is dicyandiamide-formaldehyde condensate.
^{d}(% by wt. d.s.) means the percent of the component relative to the total amount of PVOH, Wax, and Polyamine.
^{e}In the control sample, the paper had no treatment

All compositions were diluted with distilled water to 2% solids before coating the base sheets. All sheets were coated using a Gardco Automated Draw Down Machine to obtain a specific wet film of coating and then dried on a LabTech Instruments Inc., Speedy Dryer for 3 minutes at 105° C. Grease resistance was then measured by using TAPPI TEST METHOD T-559 and reported as Kit numbers (Kit #'s). In the last column on the right, the 0.1 ml water drop size is an indication of the wetting of the sheet and water repellency. In this test, distilled water (0.1 ml) was applied to the coated sheets using an automatic pipette and the diameter of the water drop on the sheet was measured with a ruler. The larger the water drop diameter, the more wettable the sheet and the lower the water repellency. Those results are shown in Table 3.

TABLE 3
Kit numbers for grease resistance and water repellency for
paper treated with the compositions shown in Tables 1 and
2 at various dosage rates.

| | | Drawdown Rod # | | | | Size of |
|---|---|---|---|---|---|---|
| | | 20 | 15 | 10 | 5 | 0.1 ml |
| | | Kit #'s @ Pounds dry/ | | | | water |
| | Composition Weight | 3000 ft² Dosage | | | | drop |
| Composition | Ratio (B/C) | 0.624 | 0.468 | 0.312 | 0.156 | (mm) |

Using 20.5 lb/3000 ft² Base Sheet

| | | | | | | |
|---|---|---|---|---|---|---|
| D | 95/5 | 4 | 5 | 4 | <3 | 8 |
| E | 90/10 | 8 | 7 | 5 | 3 | 8 |
| F | 70/30 | 6 | 7 | 6 | 5 | 7 |
| G | 50/50 | 5 | 5 | 5 | 4 | 7 |
| H | 30/70 | 5 | 5 | 4 | 4 | 7 |
| I | 10/90 | 5 | 5 | 4 | 4 | 7 |

Using 20 lb/3000 ft² Base weight

| | | | | | | |
|---|---|---|---|---|---|---|
| A | Composition A | 2 | 2 | | 1 | 10 |
| B | Composition B | 2 | 1 | | 1 | 10 |
| C | Composition C | 3 | 3 | | 3 | 7 |
| F | 70/30 (B/C) | 7 | 6 | | 4 | 7 |
| J | 70/30 (A/C) | 6 | 5 | | 4 | 7 |
| Control | No additives | 0 | 0 | 0 | 0 | 12 |

### Discussion:

As the data show, compositions A, B, and C alone as a coating at various dosages add little to no grease/oil resistance to the paper substrate. At even the highest levels of application, the highest Kit number obtained was 3. However, upon blending Composition A (PVOH) and Composition C (paraffin wax) a noted increase in Kit number is observed (Kit number 2-3 up to Kit number 5-6), even at the same total dosage of solids. The incorporation of the polyamine into the combination with poly(vinyl alcohol) and wax (noted as Composition F), but at the same level of solids dosage, further increases the Kit number to 6-7.

The results for Compositions D-I show that an optimum in grease/oil resistance is established with the blending of the paraffin wax to the poly(vinyl alcohol)/polyamine blend, as indicated by the data in Tables 2 and 3.

As for water repellency, the uncoated sheet resulted in a water drop diameter of 12 mm compared to a range of 7-8 mm for the treated samples. Furthermore, the uncoated sheet resulted in the water spreading over time and soaking into the sheet, whereas the sheets coated with Compositions D-I, as well as Composition C, showed smaller water drop diameters, thus indicating improved water repellency, and showed no drop spreading over time and no soaking in of the water drop. Paper coated with Compositions A and B showed slightly improved water repellency over the control, however there was some droplet spread over time, but the drops did not soak into the sheets.

It can be concluded from the data that a combination of wax and poly(vinyl alcohol) provided significantly improved grease and water resistance to papers coated with the combination. Because the improvement was obtained without any increase at all in the total amount of solids used for the treatment, It is believed that such an increase is unexpected. Furthermore, when a polyamine was added to the combination, the grease and water resistance was further increased, and again without any increase in the total amount of solids used in the treatment. Therefore, it is believed that the addition of a polyamine to the combination of wax and poly(vinyl alcohol) used as a paper coating provides an unexpected improvement in the grease and/or water resistance of the coated material.

### EXAMPLE 1

This illustrates the efficacy of applying a wax/poly(vinyl alcohol)/polyamine coating to coated and uncoated paperboard according to the present method.

A coating having the composition of formulation “F” of the Comparative Example 1, above, was applied to coated and uncoated 190# whiteboard by using a Gardco Auto Draw II automated drawdown machine (Paul N. Gardner Company, Inc., Pompano Beach, Fla.) operating at 1.5 inch/second coat speed and using drawdown wire coating rods of different sizes to obtain coatings of different thicknesses. The coated paperboard had been commercially coated with a polymer latex binder/filler formulation prior to the application of the wax/PVOH/polyamine coating.

The wax/PVOH/polyamine coating comprised 38.4% poly(vinyl alcohol) Celvol 840, from Celanese Corporation, 54.9% paraffin wax having a melting point of 52°-58° C. from Sigma-Aldrich, and 6.6% dicyandiamide-formaldehyde condensate as the polyamine (all percentages are on a percent of dry matter basis). The components were dispersed in distilled water and applied to the paperboard at a solids concentration of 6% or 8%. Films of several different thicknesses were used. The method of coating and drying was the same as described above in Comparative Example 1, as was the method of measuring grease resistance (Kit Number). Table 4 shows film thicknesses, product application rates and Kit Numbers resulting from coatings placed on uncoated (1-8) and coated (9-12) paperboard.

TABLE 4
Grease resistance of 190# white paperboard with and without a
latex polymer/filler precoat and with different application rates of a
wax/PVOH/polyamine second coating.

| | | | COATING APPLICATION RATE | | | |
|---|---|---|---|---|---|---|
| | | FILM | DRY | DRY | COATING | |
| TEST | ROD | THICKNESS | SOLIDS | SOLIDS | FORMULATION | KIT |
| NO. | NO. | (IN.) | (lbs/3000 ft²) | (lbs/ton) | (lbs/ton)^{a} | NUMBER |

UNCOATED 190# WHITEBOARD

| | | | | | | |
|---|---|---|---|---|---|---|
| 0UN^{b} | — | — | 0 | 0 | 0 | 0 |
| 1 | 6 | .00060 | 0.56 | 5.896 | 25.64 | 0 |
| 2 | 10 | .00100 | 0.94 | 9.827 | 42.73 | 0 |
| 3 | 15 | .00150 | 1.40 | 14.740 | 64.09 | 0 |
| 4 | 20 | .00200 | 1.87 | 19.654 | 85.45 | 1 |
| 5 | 25 | .00250 | 2.34 | 24.567 | 106.82 | 1 |
| 6 | 30 | .00300 | 2.81 | 29.481 | 128.18 | 2 |
| 7 | 20 | .00200 | 2.50 | 26.205 | 113.94 | 2 |
| 8 | 30 | .00300 | 3.74 | 39.308 | 170.90 | 3 |

COATED 190# WHITEBOARD

| | | | | | | |
|---|---|---|---|---|---|---|
| 0CO^{b} | — | 0 | 0 | 0 | 0 | 0 |
| 9 | 6 | .00060 | 0.56 | 5.896 | 25.64 | 4 |
| 10 | 10 | .00100 | 0.94 | 9.827 | 42.73 | 5 |
| 11 | 15 | .00150 | 1.40 | 14.740 | 64.09 | 8 |
| 12 | 20 | .00200 | 1.87 | 19.654 | 85.45 | 12 |

Notes:
^{a}This refers to the number of pounds of a formulation of the wax/PVOH/polyamine coating at 23% solids in water that was applied per ton of dry paper. That formulation was diluted further prior to application with water to 6% solids for tests 1–6 and 9–12 and to 8% solids for tests 7 and 8.
^{b}0UN refers to uncoated paperboard with no wax/PVOH/polyamine coating; 0CO refers to coated paperboard with no wax/PVOH/polyamine coating.

The results of this test showed that while the application of a coating comprising wax, PVOH, and polyamine improved the grease resistance of the uncoated whiteboard from 0 Kit number to about 3, as the application rate of the coating formulation increased up to about 170 lbs of the 23% actives formulation/ton of paper (about 39 lbs dry solids/ton of paper), the application of the same coating at a much lower level to pre-coated whiteboard provided unexpectedly superior increases in grease resistance. Coated whiteboard without the subsequent wax/PVOH/polyamine coating had a Kit number of 0. However, the grease resistance of the board increased significantly in a dose-responsive manner up to a Kit number12 at a coating rate of about 19.8 lbs dry solids/ton of paper of the wax/PVOH/polyamine coating (about 85 lbs of the 23% actives formulation/ton of paper).

Based on the results shown in Comparative Example 1, it is believed that the treatment of a pre-coated porous material with a wax/PVOH coating, without the use of the optional polyamine, would also be useful in increasing the grease resistance of the pre-coated material.

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions by those of ordinary skill in the art without departing from the scope of the invention, it is intended that all matter contained in the above description shall be interpreted as illustrative and not in a limiting sense. In addition it should be understood that aspects of the various embodiments may be interchanged both in whole or in part.

What is claimed is:

1. A method of improving the gas, water, water vapor, or grease resistance of a porous material, the method comprising:
applying to the porous material a first treatment agent; and after the first treatment agent has been applied to the porous material
applying to a surface of the porous material wax, poly(vinyl alcohol), and optionally a polyamine, thereby improving the gas, water, water vapor, or grease resistance of the porous material.

2. The method according to claim 1, wherein the step of applying the first treatment agent comprises applying the first treatment agent to a surface of the porous material to form a first coating.

3. The method according to claim 2, wherein the step of applying the wax, poly(vinyl alcohol), and optional polyamine comprises applying the wax, poly(vinyl alcohol), and optional polyamine over the first coating to form a wax/poly(vinyl alcohol) coating which optionally comprises a polyamine.

4. The method according to claim 3, wherein the step of applying the wax, poly(vinyl alcohol), and optional polyamine comprises applying the wax, poly(vinyl alcohol) and polyamine to form a wax/poly(vinyl alcohol)/polyamine coating.

5. The method according to claim 1, wherein improving the gas, water, water vapor, or grease resistance of the porous material comprises increasing the grease resistance of the porous material as measured by Kit number and wherein the wax, poly(vinyl alcohol) and optional polyamine are applied in an amount sufficient to improve the grease resistance by at least 3 Kit numbers.

6. The method according to claim 1, wherein improving the gas, water, water vapor, or grease resistance of the porous material comprises increasing the grease resistance of the porous material as measured by Kit number and wherein the wax, poly(vinyl alcohol) and optional polyamine are applied in an amount sufficient to improve the grease resistance by at least a factor of 2 but no less than 2 Kit numbers.

7. The method according to claim 1, wherein the porous material comprises a material that is selected from the group consisting of paper, asphalt, asphalt laminations, wood, textile fabric, yarn, thread, formed articles and medical dressings.

8. The method according to claim 1, wherein the porous material comprises paper and is selected from the group consisting of cardboard, bakery board, butter chips, margarine chips, candy board, cup stock, frozen food containers, plate stock, artist's papers, carbonizing tissue, carton overwraps, cover paper, text paper, envelopes, garbage bags, trash bags, label papers, paper placemats, release papers, soap containers, wallpaper, liner board, folding cartons, multiwall bags, flexible packaging, duplicator paper, reproduction papers, medical dressings, and support cards.

9. The method according to claim 1, wherein the porous material comprises textile fabric and is selected from the group consisting of carpet, medical dressings, woven fabrics and non-woven fabrics.

10. The method according to claim 1, wherein the first treatment agent comprises a fluorochemical compound.

11. The method according to claim 1, wherein the first treatment agent comprises a polymer binder.

12. The method according to claim 11, wherein the polymer binder is selected from the group consisting of poly(vinyl alcohol), polyacrylate, polystyrene/polyacrylic copolymer, cellulose derivative, nitrocellulose, vinyl chloride, vinyl chloride copolymers, vinyl acrylate copolymers, vinyl acetate homopolymers, vinyl acetate copolymers, styrene butadiene polymers, styrene butadiene acrylonitrile polymers, polyvinylacetate, proteins, milk proteins, starch, and mixtures of any of these.

13. The method according to claim 1, wherein the first treatment agent comprises wax, poly(vinyl alcohol) and optionally a polyamine.

14. The method according to claim 1, wherein the first treatment agent comprises wax, poly(vinyl alcohol) and a polyamine.

15. The method according to claim 11, wherein the first treatment agent further comprises one or more synthetic pigments, minerals, organic opacifiers, lubricants, surface sizes, starch, saturants, release coatings, rheology modifiers, dispersants, insolubilizers, or plasticizers.

16. The method according to claim 15, wherein the first treatment agent further comprises a plasticizer that is selected from the group consisting of dioctyl phthalate, tricresyl phosphate, castor oil, and mixtures thereof.

17. The method according to claim 15, wherein the first treatment agent further comprises a mineral selected from calcium carbonate, titanium dioxide, Kaolin clay, Montmorillionite clay, gypsum, or a mixture thereof.

18. The method according to claim 1, wherein the wax is an animal wax, a mineral wax, a vegetable wax, a synthetic wax or a mixture thereof.

19. The method according to claim 1, wherein the wax is selected from the group consisting of paraffin wax, beeswax, bayberry-myrtle, candelilla, caranday, carnauba, castor bean wax, esparto grass wax, Japan wax, montan crude wax, ouricury, retamo-ceri nimbi, shellac wax, spermaceti, sugar cane wax, wool wax-lanolin, polyethylene wax, poly(ethylene-acrylate) wax, or a mixture of any two or more of these.

20. The method according to claim 1, wherein the wax is a paraffin wax.

21. The method according to claim 1, wherein the paraffin wax comprises a mixture of predominantly non-aromatic saturated hydrocarbons with the general formula CₙH₍₂ₙ₊₂₎,
where n is an integer between 12 and 50.

22. The method according to claim 21, where n is an integer between 22 and 27.

23. The method according to claim 22, wherein the paraffin wax has a melting point range between about 47° C. and abut 95° C., and is insoluble in water.

24. The method according to claim 1, wherein the poly(vinyl alcohol) is selected from the group consisting of super hydrolyzed poly(vinyl alcohol), full hydrolyzed poly(vinyl alcohol), intermediate hydrolyzed poly(vinyl alcohol), partially hydrolyzed poly(vinyl alcohol), and mixtures thereof.

25. The method according to claim 1, wherein the poly(vinyl alcohol) is intermediate hydrolyzed poly(vinyl alcohol) or partially hydrolyzed poly(vinyl alcohol).

26. The method according to claim 1, wherein the treatment comprises applying the poly(vinyl alcohol) and the wax to a sheet material at the combined rate of about 0.1 to about 3.0 lbs dry solids (d.s.) per 3000 ft² of surface of the material.

27. The method according to claim 1, wherein the treatment comprises applying the poly(vinyl alcohol) and the wax to a sheet material at the combined rate of about 0.15 to about 2.0 lbs d.s./3000 ft² of surface of the material.

28. The method according to claim 1, wherein the treatment comprises applying the poly(vinyl alcohol) and the wax to a sheet material at the combined rate of about 0.15 to about 1.0 lbs d.s./3000 ft² of surface of the material.

29. The method according to claim 1, wherein the treatment comprises applying the poly(vinyl alcohol) and the wax to the material in a ratio of the poly(vinyl alcohol) to the wax, by weight, that is within a range of about 10:90 to about 90:10.

30. The method according to claim 1, wherein the treatment comprises applying the poly(vinyl alcohol) and the wax to the material in a ratio of the poly(vinyl alcohol) to the wax, by weight, that is within a range of about 40:60 to about 60:40.

31. The method according to claim 14, wherein the polyamine comprises one or more of a polyoxyalkyleneamine, a polyoxyalkylenediamine, a polyoxyalkylenetriamine, or an amine-aldehyde condensate that is the reaction product of an amine containing an active hydrogen atom and an aldehyde.

32. The method according to claim 31, wherein the amine is selected from the group consisting of guanidine, urea, dicyandiamide, melamine, aniline, ethylenediamine, diethylenetriamine, monoethanolamine, diethanolamine, polyoxyalkyleneamines, polyoxyalkylenediamines, polyoxyalkylenetriamines, and mixtures thereof.

33. The method according to claim 31, wherein the aldehyde is selected from the group consisting of formaldehyde, acet aldehyde, glutaraldehyde, glyoxal, hexamethylenetetramine, paraformaldehyde, and mixtures thereof.

34. The method according to claim 14, wherein the polyamine comprises a polyoxyalkyleneamine, a polyoxyalkylenediamine, a polyoxyalkylenetriamine, a dicyandiamide-formaldehyde condensate, or a mixture thereof.

35. The method according to claim 14, wherein the poly(vinyl alcohol) and the wax and the polyamine are applied in amounts wherein the poly(vinyl alcohol) is within a range of about 3 to about 74% by wt. d.s., the wax is within a range of about 13-96 % by wt. d.s., and the polyamine is within a range of about 0.5-13% by wt. d.s., wherein the dry solids basis includes only the poly(vinyl alcohol), wax, and polyamine.

36. The method according to claim 14, wherein the poly(vinyl alcohol) and the wax and the polyamine are applied in amounts wherein the poly(vinyl alcohol) is within a range of about 22 to about 68% by wt. d.s., the wax is within a range of about 25-74% by wt. d.s., and the polyamine is within a range of about 3-12% by wt. d.s., wherein the dry solids basis includes only the poly(vinyl alcohol), wax, and polyamine.

37. The method according to claim 14, wherein the poly(vinyl alcohol) and the wax and the polyamine are applied in amounts wherein the poly(vinyl alcohol) is within a range of about 38 to about 68% by wt. d.s., the wax is within a range of about 25-55% by wt. d.s., and the polyamine is within a range of about 6-12% by wt. d.s., wherein the dry solids basis includes only the poly(vinyl alcohol), wax, and polyamine.

38. The method according to claim 14, wherein the poly(vinyl alcohol), wax, and polyamine are applied in a weight ratio of the three components, respectively, of about 4/5/1, or 5/4/1, or 4.5/4.5/1.

39. The method according to claim 1, wherein the poly(vinyl alcohol) and wax are applied together in a composition.

40. The method according to claim 14, wherein the poly(vinyl alcohol), wax, and polyamine are applied together in a composition.

41. A porous material having improved gas, water, water vapor and/or grease resistance comprising the porous material having a surface on which is a first coating of a first treatment agent and a second coating comprising wax, poly(vinyl alcohol) and optionally a polyamine over the first coating.

42. The porous material according to claim 41, wherein the porous material comprises a material that is selected from the group consisting of paper, asphalt, asphalt laminations, wood, textile fabric, yarn, thread, formed articles and medical dressings.

43. The porous material according to claim 41, comprising a paper material that is selected from the group consisting of cardboard, bakery board, butter chips, margarine chips, candy board, cup stock, frozen food containers, plate stock, artist's papers, carbonizing tissue, carton overwraps, cover paper, text paper, envelopes, garbage bags, trash bags, label papers, paper placemats, release papers, soap containers, wallpaper, liner board, folding cartons, multiwall bags, flexible packaging, duplicator paper, reproduction papers, medical dressings, and support cards.

44. The porous material according to claim 41, comprising a textile fabric that is selected from the group consisting of carpet, medical dressings, woven fabrics and non-woven fabrics.

45. The porous material according to claim 41, wherein the first treatment agent comprises a fluorochemical compound.

46. The porous material according to claim 41, wherein the first treatment agent comprises a polymer binder.

47. The porous material according to claim 46, wherein the polymer binder is selected from the group consisting of poly(vinyl alcohol), polyacrylate, polystyrene/polyacrylic copolymer, cellulose derivative, nitrocellulose, vinyl chloride, vinyl chloride copolymers, vinyl acrylate copolymers, vinyl acetate homopolymers, vinyl acetate copolymers, styrene butadiene polymers, styrene butadiene acrylonitrile polymers, polyvinylacetate, proteins, milk proteins, starch, and mixtures of any of these.

48. The porous material according to claim 41, wherein the first treatment agent comprises wax, poly(vinyl alcohol) and optionally a polyamine.

49. The porous material according to claim 41, wherein the first treatment agent comprises wax, poly(vinyl alcohol) and a polyamine.

50. The porous material according to claim 41, wherein the first treatment agent further comprises one or more synthetic pigments, minerals, organic opacifiers, lubricants, surface sizes, starch, saturants, release coatings, rheology modifiers, dispersants, insolubilizers, or plasticizers.

51. The porous material according to claim 41, wherein the first treatment agent further comprises a mineral selected from calcium carbonate, titanium dioxide, Kaolin clay, Montmorillionite clay, gypsum, or a mixture thereof.

52. The porous material according to claim 41, wherein the wax included in the second coating comprises an animal wax, a mineral wax, a vegetable wax, a synthetic wax or a mixture thereof.

53. The porous material according to claim 41, wherein the wax included in the second coating is selected from the group consisting of paraffin wax, beeswax, bayberry-myrtle, candelilla, caranday, carnauba, castor bean wax, esparto grass wax, Japan wax, montan crude wax, ouricury, retamo-ceri nimbi, shellac wax, spermaceti, sugar cane wax, wool wax-lanolin, polyethylene wax, poly(ethylene-acrylate) wax, or a mixture of any two or more of these.

54. The porous material according to claim 41, wherein the wax included in the second coating is paraffin wax.

55. The porous material according to claim 54, wherein the paraffin wax comprises a mixture of predominantly non-aromatic saturated hydrocarbons with the general formula CₙH₍₂ₙ₊₂₎,
where n is an integer between 12 and 50.

56. The porous material according to claim 55, where n is an integer between 22 and 27.

57. The porous material according to claim 54, wherein the paraffin wax has a melting point range between about 47° C. and abut 95° C., and is insoluble in water.

58. The porous material according to claim 41, wherein the poly(vinyl alcohol) included in the second coating is selected from the group consisting of super hydrolyzed poly(vinyl alcohol), full hydrolyzed poly(vinyl alcohol), intermediate hydrolyzed poly(vinyl alcohol), partially hydrolyzed poly(vinyl alcohol), and mixtures thereof.

59. The porous material according to claim 41, wherein the poly(vinyl alcohol) included in the second coating is intermediate hydrolyzed poly(vinyl alcohol) or partially hydrolyzed poly(vinyl alcohol).

60. The porous material according to claim 41, wherein the second coating includes the poly(vinyl alcohol) and the wax in a ratio, by weight, that is within a range of about 10:90 to about 90:10.

61. The porous material according to claim 41, wherein the second coating includes the poly(vinyl alcohol) and the paraffin wax in a ratio, by weight, that is within a range of about 40:60 to about 60:40.

62. The porous material according to claim 41, wherein the second coating comprises a polyamine.

63. The porous material according to claim 62, wherein the polyamine comprises a polyoxyalkyleneamine, a polyoxyalkylenediamine, a polyoxyalkylenetriamine, or an amine-aldehyde condensate that is the reaction product of an amine containing an active hydrogen atom and an aldehyde.

64. The porous material according to claim 63, wherein the amine is selected from the group consisting of guanidine, urea, dicyandiamide, melamine, aniline, ethylenediamine, diethylenetriamine, monoethanolamine, diethanolamine, polyoxyalkyleneamines, polyoxyalkylenediamines, polyoxyalkylenetriamines, and mixtures thereof.

65. The porous material according to claim 64, wherein the aldehyde is selected from the group consisting of formaldehyde, acet aldehyde, glutaraldehyde, glyoxal, hexamethylenetetramine, paraformaldehyde, and mixtures thereof.

66. The porous material according to claim 62, wherein the polyamine comprises at least one of a polyoxyalkyleneamine, a polyoxyalkylenediamine, a polyoxyalkylenetriamine, a dicyandiamide-formaldehyde condensate, or a mixture thereof.

67. The porous material according to claim 62, comprising the poly(vinyl alcohol) within a range of about 3 to about 74% by wt. d.s., the wax within a range of about 13-96% by wt. d.s., and the polyamine within a range of about 0.5-13% by wt. d.s., wherein the dry solids basis includes only the poly(vinyl alcohol), wax, and polyamine.

68. The porous material according to claim 62, comprising the poly(vinyl alcohol) within a range of about 22 to about 68% by wt. d.s., the wax within a range of about 25-74% by wt. d.s., and the polyamine within a range of about 3-12% by wt. d.s., wherein the dry solids basis includes only the poly(vinyl alcohol), wax, and polyamine.

69. The porous material according to claim 62, comprising the poly(vinyl alcohol) within a range of about 38 to about 68% by wt. d.s., the wax within a range of about 25-55% by wt. d.s., and the polyamine within a range of about 6-12% by wt. d.s., wherein the dry solids basis includes only the poly(vinyl alcohol), wax, and polyamine.

70. The porous material according to claim 62, wherein the second coating comprises poly(vinyl alcohol), wax, and polyamine in a weight ratio of the three components, respectively, of about 4/5/1, or 5/4/1, or 4.5/4.5/1.

71. A porous material that has been treated by the method according to claim 1.
